(19) United States
(12) Patent Application Publication
(10) Pub. No.: US 2003/0018496 A1
(43) Pub. Date: Jan. 23, 2003

(54) System and user interface for use in billing for services and goods

(75) Inventors: Lynn Hambright, Chester Springs, PA (US); Douglas J. Cole, Valley Forge, PA (US); Geraldine Miklowcic, Chester Springs, PA (US); Nicholas Conti, Spring City, PA (US); Starr Stanley, Norristown, PA (US)

Correspondence Address: Elsa Keller, Legal Assistant, Intellectual Property Department, SIEMENS CORPORATION, 186 Wood Avenue South, Iselin, NJ, 08830, US

(73) Assignee: Siemens Medical Solutions Health Services Corporation

(21) Appl. No.: 10/005,137

(22) Filed: Dec. 5, 2001

Related U.S. Application Data
(60) Provisional application No. 60/302,065, filed on Jun. 29, 2001.

(51) Int. Cl. G06F 17/60

(52) U.S. Cl. 705/2; 705/34

(57) ABSTRACT

A system consolidates records of services from multiple customer accounts, encounters, cases or visits into one account to facilitate comprehensive billing and reimbursement compatible with selected contract (e.g., Medicare health plan) rules for disparate services provided to a customer. A method determines payment for provision of multiple different services based on predetermined reimbursement rules. The method involves receiving a record identifying a service provided to a specific entity and automatically creating a reimbursement record. The reimbursement record groups an item identifying the provided service together with an item identifying an other service provided to the specific entity based on predetermined service record allocation rules. A reimbursement amount for the identified provided service and the other service provided to the specific entity is calculated based on a reimbursement contract. Predetermined allocation rules are automatically applied for identifying a reimbursement record indicating a group of services provided to the specific entity on separate occasions to be billed together on a single bill.

This is a non-provisional application of provisional application serial No. 60/302,065 by G. Miklowcic et al. filed Jun. 29, 2001.

### FIELD OF THE INVENTION

This invention concerns a system and user interface for determining payment and billing for provision of multiple different services and goods based on predetermined reimbursement rules for use in healthcare, insurance or other financial systems.

### BACKGROUND OF THE INVENTION

In hospital patient registration, administration and billing systems a front-office administrative person manually makes a patient accounting decision determining how services provided to a patient are to be billed. This decision is typically taken before a thorough clinical assessment has been made of the medical condition of the patient and before an expert clinical opinion of the condition of the patient is taken. Given the complexity of healthcare insurance plan reimbursement and billing rules, the administrative person charged with making the billing decision is unlikely to have the knowledge and tools required to accurately establish an appropriate payment reimbursement and billing mechanism tailored to the services required by the patient.

One known system processes and combines individual billing accounts for reimbursement that are generated as a result of providing services to a patient. Another system creates both clinical and administrative records that track the multiple services provided to a patient. These approaches are error prone, inefficient, frequently require manual intervention by a customer to correct information and suffer from numerous other deficiencies resulting in customer dissatisfaction. Specifically, such approaches may involve reconciling administrative and clinical records by manual or automated processing after the services have been provided resulting in reconciliation errors which are not discovered until a claim (request for payment) is rejected by the payer. This leads to a major delay in a customer receiving reimbursement. These problems and derivative deficiencies are addressed by a system according to invention principles.

### SUMMARY OF INVENTION

A system consolidates records of services from multiple customer accounts, encounters, cases or visits into one account to facilitate comprehensive billing and reimbursement compatible with selected contract (e.g., Medicare health plan) rules for disparate services provided to a customer. A method determines payment for provision of multiple different services based on predetermined reimbursement rules. The method involves receiving a record identifying a service provided to a specific entity and automatically creating a reimbursement record. The reimbursement record groups an item identifying the provided service together with an item identifying an other service provided to the specific entity based on predetermined service record allocation rules. A reimbursement amount for the identified provided service and the other service provided to the specific entity is calculated based on a reimbursement contract.

In a feature of the invention, predetermined allocation rules are automatically applied for identifying a reimbursement record indicating a group of services provided to the specific entity on separate occasions to be billed together on a single bill.

### BRIEF DESCRIPTION OF THE DRAWING

FIG. 1 shows a system for correctly grouping records of services provided to a specific patient and providing a consolidated reimbursement claim to a payer, according to invention principles.

FIG. 2 shows a flowchart of a process for correctly grouping records of services provided to a specific patient and providing a consolidated reimbursement claim to a payer, according to invention principles.

FIG. 3 shows a displayed consolidated reimbursement record including grouped records of services provided to a specific patient, according to invention principles.

FIG. 4 shows an exemplary contract structure for use in healthcare reimbursement, according to invention principles.

FIG. 5 shows a system for grouping records of outpatient services provided to a specific patient in a consolidated reimbursement record, according to invention principles.

FIG. 6 shows a system for grouping records of inpatient services provided to a specific patient in a consolidated reimbursement record, according to invention principles.

FIG. 7 shows a system for grouping records of inpatient and outpatient services provided to a specific patient in a consolidated reimbursement record, according to invention principles.

### DETAILED DESCRIPTION OF THE DRAWINGS

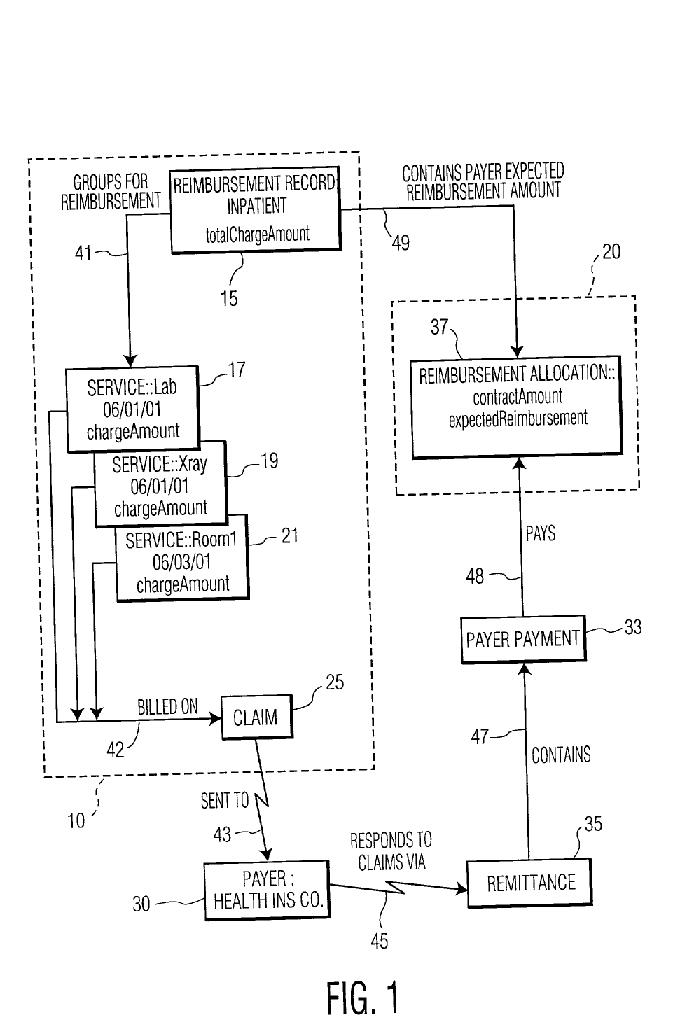

FIG. 1 shows a system for correctly grouping records of services provided to a specific patient and providing a consolidated reimbursement claim to a payer. Although the system is described in the context of a healthcare financial record processing system this is exemplary only. The system may be implemented in any commercial or financial record processing environment involving processing records derived from providing different services to a specific entity. Such a specific entity may comprises a patient, a company, an organization, an individual person or a group of people, for example. In the healthcare environment, the system enables a user to create one or more consolidated records for one patient (or multiple patients, e.g., mother/baby, or donor/transplant recipient) as necessary to support patient management functions and to allocate records of individual performed services to those consolidated records unconstrained by financial system requirements. The inventors have recognized that a problem exists in having financial system functions dependent on both administrative and operational (e.g., clinical) system requirements. The disclosed system addresses this problem by advantageously separating financial system functions from administrative and clinical system requirements and constraints. The term record is used herein to signify information or data that is material to a particular subject and that is preserved in non-volatile, permanent or tangible form such as in a computer file, disk, CDROM, DVD etc. or other electronic storage and is accessible by a computer or other electronic processing system.

The term reimbursement record is used herein to signify a grouping of services (or other events or items) that are advantageously identified as being beneficially processed and reimbursed together as a composite unit for reimbursement by a particular payer, for example. Processing these items together in a reimbursement record facilitates correct billing calculation and correct expected reimbursement calculation. In the particular embodiment of healthcare transaction processing, grouped services are initially associated with a patient encounter (e.g., visit, phone call, interview, exam etc.) with a health care system. The term reimbursement contract as used in the claims herein comprises a policy, plan, payer contract or other collection of information in electronic, paper or other embodiment incorporating rules affecting computation of reimbursement for services provided to a patient or other entity.

The disclosed system eliminates the need for manual intervention to move services from one record to another in order to satisfy a financial requirement to group services that are reimbursed together. This facilitates the system ability to calculate a correct expected reimbursement for services performed for a specific entity. The system automates the grouping of services into a reimbursement record based on rules and permits optional manual intervention at the discretion of a user though it is not required. For example, in cases where a rule determines specific services are to be combined, the system informs the user of provided services that do not qualify for combination in one reimbursement record and provides the user with a means to override the system automation.

The system determines which reimbursement record an individual record of a service belongs to, based on rules that define how a payer reimburses for the type of service performed. The rule-based system efficiently groups services for one or more patients from one or more encounters, customer accounts, cases or visits into one account for joint reimbursement. A variety of rules may be employed to group services into a reimbursement record. Rules may be derived from a contract negotiated between a payer and provider that defines the contract terms or reimbursement rates for the various types of services performed, or the rules may be payer health plan specific or may be derived from system definition or other sources.

The disclosed system uses the consolidated reimbursement record in separating the financial system functions from the administrative and clinical system requirements and constraints. Therefore, the system enables a clinician to associate a patient visit with a record of an individual service provided to the patient in a way that makes sense clinically whilst also regrouping the record of the provided service into a reimbursement record that makes sense financially. The system advantageously regroups the record of the provided service into a reimbursement record based on payer rules (e.g., in a predetermined contract) to support the accounting and collection function.

As an example, assume a contract states that a transplant is reimbursed at a case rate and includes hospital service costs and re-transplant surgery costs occurring during original transplant admission as well as hospital based care costs during a convalescent period of ninety days following a transplant. The contract also covers reimbursement for costs of routine outpatient evaluation procedures and testing during the ninety days following the transplant procedure as well as certain pre-admission testing. Typically this is performed during at least three patient encounters with the healthcare system, one for pre-admission testing, one for the transplant admission and one for each outpatient visit for testing or evaluation. However, the inventors have recognized that financially this is advantageously processed using one reimbursement record supporting the reimbursement for the services at the specified single contract rate.

Alternatively, consider a Medicare health plan rule directing that records of specified services arising from patient visits or stays occurring within a specified interval, beginning upon an inpatient visit, are to be combined. In this case, each outpatient visit is a separate encounter from the perspective of a clerk checking in the patient at the outpatient clinic. The clerk creates a new inpatient encounter record oblivious of other previous associated outpatient encounter records. The result is that an incorrect claim is submitted for reimbursement at outpatient rates for the visits designated as outpatient encounters and inpatient rates for the visits designated as inpatient encounters. The disclosed system, in contrast, evaluates the Medicare heath plan rule and combines the required services from the multiple encounters into one reimbursement record and uses this record to prepare a correct claim for reimbursement at the inpatient rate.

The system consolidates service records from multiple accounts, encounters, cases or visits into one account for billing and reimbursement based on one or more payer health plan rules (e.g., Medicare rules). Thereby avoiding errors resulting from failure to correctly group service records of clinical services and failure to apply correct reimbursement rules. This avoids claim rejection by a payer and major delay and customer dissatisfaction. Further, the system comprehensively combines records of disparate services provided to a customer on multiple occasions based on a determined relationship between the provided services. The system, for example, combines records of services provided to a patient during a complex surgery and treatment regimen such as for a transplant, including pre-admission testing and post-transplant follow-up.

The system is described as follows in connection with FIGS. 1-7. A glossary of the terms specific to the exemplary healthcare employed in the description and Figures is provided at the end of the description. FIG. 1 shows a system for correctly grouping records of services provided to a specific patient and for providing a consolidated reimbursement claim to a payer. Application 10 correctly groups (41) records of lab test 17, X-ray 19 and hospital stay 21 provided to a specific patient on separate occasions. The records are grouped in a consolidated reimbursement record 15 as a composite charge unit. The correctly grouped records in reimbursement record 15 are used by application 10 to generate (42) a healthcare insurance claim for payment 25 based on predetermined contract reimbursement rules of Healthcare Ins. Co. 30. The claim is communicated (43) to the Healthcare Ins. Co. 30 for payment. Healthcare Ins. Co. responds (45) in a timely manner with a remittance 35 containing (47) a payment 33 for the claim. The payment is provided (48) to application 20 for reconciliation with an expected reimbursement amount 37 provided (49) by application 10. Application 20 may be a separate application or be part (e.g., an object or other procedure) of application 10. Further application 10 (and 20) may be executed on a server, a PC or another computing device either operating in a network or as a standalone device. Application 20 checks the received payment against the expected reimbursement amount calculated by application 10 and presented in reimbursement allocation 37. If the amounts do not match, application 20 generates an indication to a user that there is a payment variance between the expected and received reimbursement. This signifies that either automated or manual intervention is desirable by a user. Thereby, a user is given the opportunity to accelerate payment collection and improve business cash flow in a timely manner.

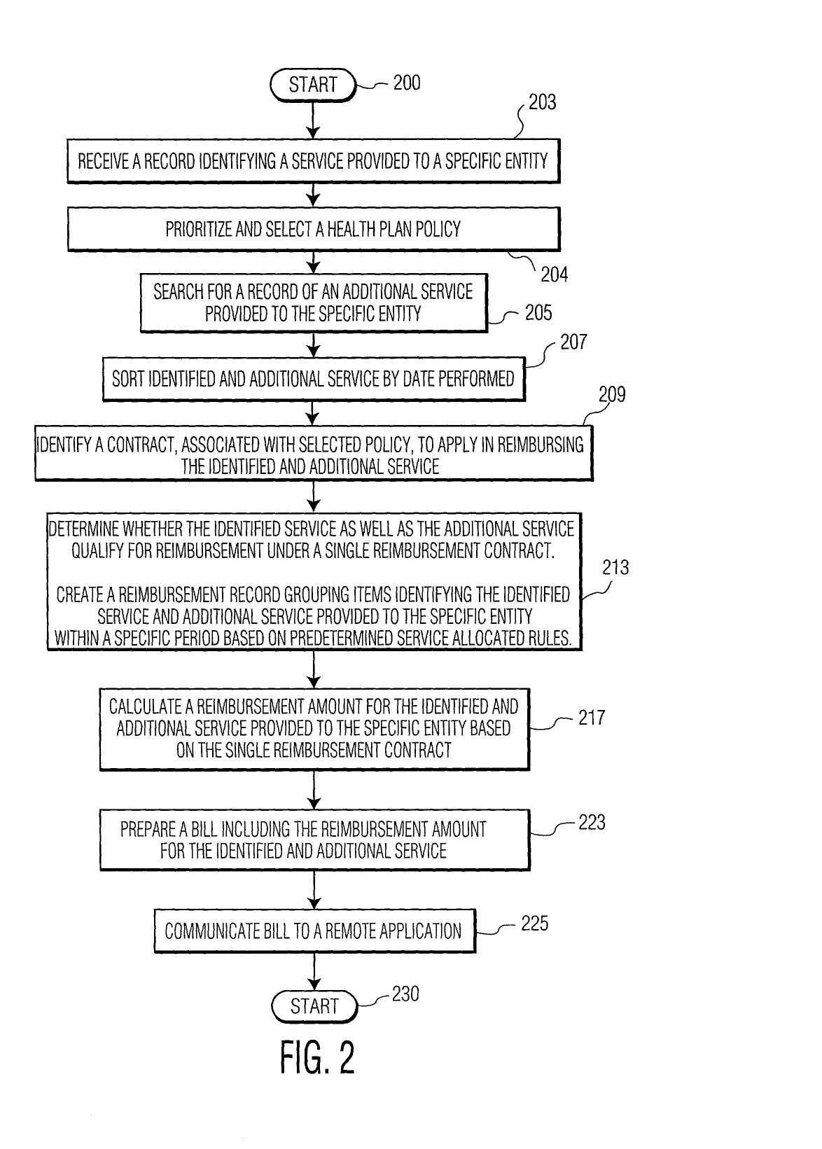

FIG. 2 shows a flowchart of a process used by application 10 of FIG. 1 for correctly grouping records of services provided to a specific patient and for providing a consolidated reimbursement claim to a payer. After the start at step 200, application 10 in step 203 acquires a record 21 (FIG. 1) identifying a service (an inpatient hospital stay) provided to a specific entity (here a patient). In step 204, application 10 prioritizes health plan policies covering the specific patient to identify and select the primary applicable policy. Specifically, application 10 in step 204 identifies and prioritizes applicable policies and associated reimbursement contracts and selects one of the identified policies based on its priority for use in determining reimbursement payment for the services identified in records 17-21 (FIG. 1). Priority is determined by whether a healthcare insurance policy is designated as a primary or secondary policy (e.g. a policy applicable via a spouse), for example. However, other contract priority relationships may also apply as determined by the contracts involved or by a contract or document detailing an encompassing contract priority hierarchy.

In step 205, application 10 searches for other records of additional services provided to the patient. The search is governed by criteria derived from an applicable health plan (having an associated reimbursement contract) that directs that records of services provided during an interval encompassing a specific date of a provided service are combined for reimbursement. The criteria in other embodiments may also direct, for example, that the search is performed for records of services associated with multiple patients (e.g., a mother and baby) or for records of particular types of services. Such search criteria may also direct that the search is performed for service records having particular identifiers or characteristics or for service records that are associated with patients having particular characteristics or have combinations of such criteria. The search of step 205 determines that records 17 and 19 (FIG. 1) also detail services provided to the patient. In step 207 application 10 sorts the identified service records (records 17-21 of FIG. 1) by the date the service was performed. In step 213 application 10 automatically creates a reimbursement record grouping items identifying provided services 17-21 based on predetermined service record allocation rules.

The predetermined service record allocation rules determine whether service record 21 identified in step 203 as well as service records 17-19 identified in step 205 qualify for reimbursement under the single selected contract. In another embodiment the allocation rules may be rules derived under a common set of reimbursement contracts. Further, in another embodiment there may be an applicable reimbursement record covering the subject records (e.g., records 17-21). In this case, the predetermined allocation rules identify an existing reimbursement record to incorporate a record item representing the identified provided service (here record 21 of FIG. 1) based on the type of the identified provided service. A service type identifier may identify a service as an inpatient service, an outpatient service or an emergency service, for example.

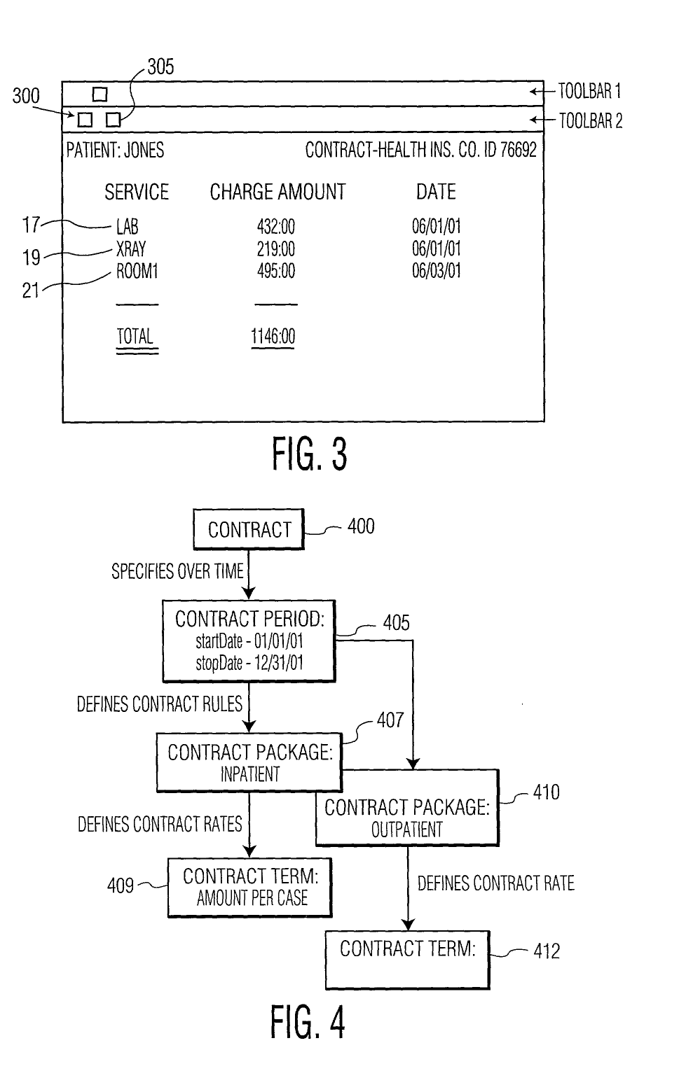

FIG. 3 shows a displayed consolidated reimbursement record including grouped service records 17-21 provided to a specific patient (Jones in this example) created in step 213 of FIG. 2. The reimbursement record is displayed in response to user selection of icon 300 shown in toolbar 2 of FIG. 3. The displayed toolbar 2 also includes an icon 305 for initiating display of a bill including the reimbursement amount for the provided services detailed in records 17-21 (FIG. 1).

Continuing with FIG. 2, application 10 in step 217 calculates a reimbursement amount for the grouped service records 17-21 based on a single reimbursement contract. FIG. 4 shows an exemplary contract structure for a contract 400 used in healthcare reimbursement. Specifically, contract 400 is applicable over a contract period 405 (Jan. 1, 2001 to Dec. 31, 2001 encompassing the inpatient and outpatient service record items 17-21 (FIG. 1). The contract includes predetermined rules 407 for computing reimbursement for inpatient charges and different rules 410 for computing reimbursement for outpatient charges. The inpatient rules 407 comprise a contract term 409 determining the amount to be reimbursed for the combined inpatient services (service item 21 of FIG. 1) provided for treatment of a particular condition on a per case basis. Similarly, the outpatient rules 410 comprise a contract term 412 determining the amount to be reimbursed for the combined outpatient services (service items 17 and 19 of FIG. 1) provided for treatment of a particular condition. Application 10 in step 217 applies the reimbursement rules 407 (FIG. 4) in determining the correct reimbursement amounts for inclusion in the reimbursement record previously created in step 213. Specifically, application 10 uses reimbursement rules 407 (for the selected health plan policy) and rules 407 require that outpatient service records (service items 17 and 19 of FIG. 1) are combined with inpatient service records (item 21 of FIG. 1). Rules 407 further require that the reimbursement for service item 17-21 occurs at the inpatient rate (contract term 409 of FIG. 4). In step 223, application 10 uses the reimbursement record for preparing a bill for the services detailed in records 17-21. The bill is communicated to a remote application in step 225 and the process of FIG. 2 ends at step 230.

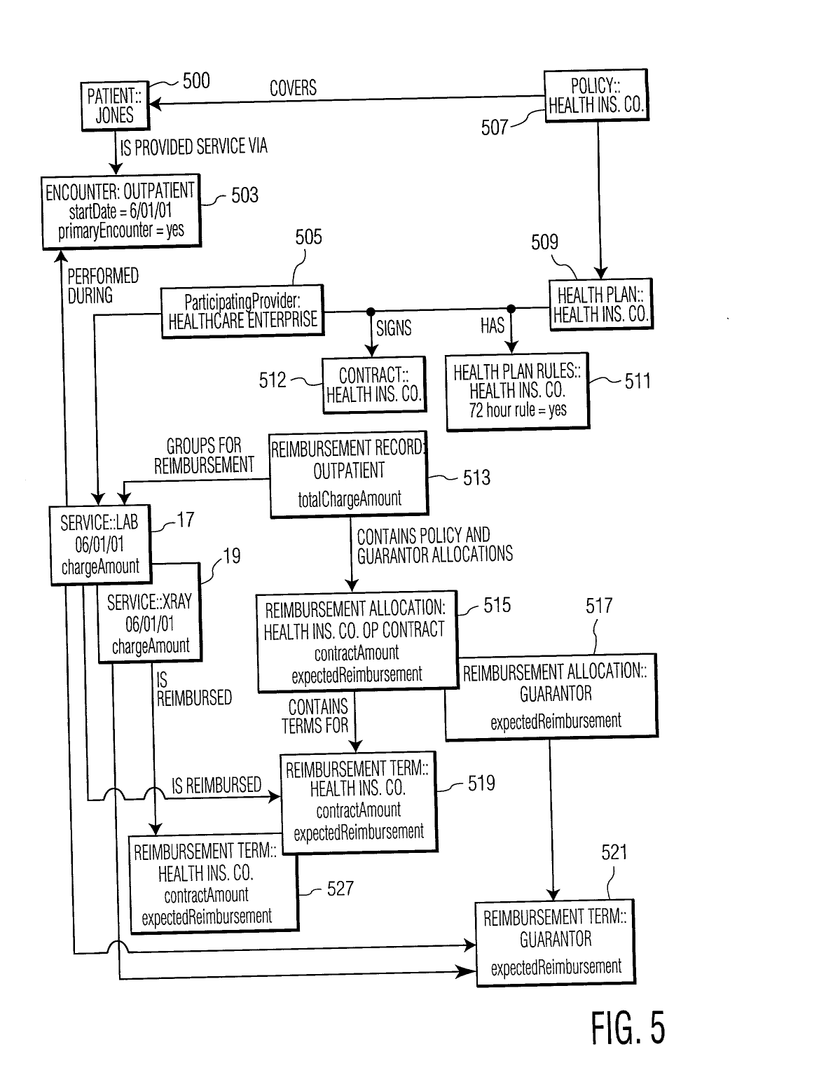

FIG. 5 shows a system employed by application 10 for grouping records of outpatient services provided to a specific patient in a consolidated reimbursement record. In this exemplary embodiment, a Healthcare Enterprise 505 includes an Outpatient Clinic and a Hospital. The Healthcare Enterprise 505 is set up as a participating provider that signs a contract 512 with Health Ins. Co. The contract is for a health plan 509 with a policy 507 covering a patient 500 (Ms. Jones) and involving health plan reimbursement rules 511. Ms. Jones visits (503) the Outpatient Clinic of Enterprise 505 on Jun. 1, 2001 for some tests. The registrar creates a visit record (an outpatient encounter record 503) for Ms. Jones and enters information about Ms. Jones, including what (insurance) policies she has in the encounter record via application 10. Specifically, the registrar via application 10 enters data indicating Ms. Jones has one policy 507 for Health Ins. Co. plan 509. Application 10 designates the visit of Jun. 1, 2001 as a primary encounter. Tests are performed on Ms. Jones and a record of these tests is entered in the outpatient encounter record 503 via application 10. In the system of FIG. 5, one service is processed at a time. The processing involves both determining which reimbursement record the service belongs to and calculating an expected reimbursement amount.

In the exemplary processing embodiment of FIG. 5, a first service is recorded (item 17 FIG. 1) by application 10 for Ms. Jones' Outpatient Encounter of Jun. 1, 2001. Application 10 retrieves a prioritized list of policies applicable to the Outpatient Encounter 17 for the participating provider Healthcare Enterprise 505. In this case the Health Ins. Co. policy 507 is both the sole applicable policy and the primary policy. Application 10 examines Health Ins. Co. plan 509 to see if there are rules defined for grouping services from multiple encounters into one reimbursement record such as for grouping emergency room services with inpatient services, or grouping pre-admission testing services with inpatient services, etc. Application 10 determines that there is a rule 511 requiring combination of records of outpatient services and inpatient services. Specifically, rule 511 requires that records of outpatient services for encounters occurring within 3 days of an inpatient encounter are to be grouped into the same inpatient reimbursement record with the records of associated inpatient services.

Application 10 searches a record repository for other encounter records for patient 500 (Ms. Jones), for the same primary policy, i.e., Health Ins. Co., and for the same participating provider, i.e., Healthcare Enterprise 505. In this example, application 10 finds that there no other encounter records satisfying rule 511. Application 10 also determines that there is a payer contract 512 defined for Health Ins. Co. Health Plan 509 in which participating provider Healthcare Enterprise 505 participates. Further, application 10 determines that the service qualifies for an active contract period and contract package, i.e., an Outpatient Package, based on primary Outpatient Encounter data. As a result application 10 searches the record repository for an existing reimbursement record and for any other reimbursement records created for any patient encounters that are linked to a primary Outpatient Encounter. In this example application 10 finds none.

Consequently, application 10 creates Outpatient Reimbursement record 513 for a primary Outpatient Encounter, for the primary Health Ins. Co. policy 509, for the participating provider 505, for the associated contract package 512. Application 10 also creates a Health Ins. Co. Reimbursement Allocation 515 for the Outpatient Reimbursement record 513. The Reimbursement Allocation 515 contains an expected reimbursement amount for Ms. Jones' Outpatient Encounter of Jun. 1, 2001 due from Health Ins. Co. Application 10 further creates a Guarantor Reimbursement Allocation 517 for the Outpatient Reimbursement record 513. Guarantor Reimbursement Allocation 517 contains the expected reimbursement amount that is guaranteed by a Guarantor.

Application 10 determines that the Outpatient Encounter service of Jun. 1, 2001 (service record 17) qualifies for an active benefit period and that this service is covered under plan 509 and policy 507. Further, application 10 determines that the service provided on Jun. 1, 2001 (of record 17) qualifies for a contract reimbursement term, i.e., an Outpatient Services term. Further, the contract reimbursement term comprises a contract rate specifying the reimbursement amount is a percentage of a charge amount charged by the provider 505. Application 10 calculates the contract reimbursement amount and creates a reimbursement term 519 incorporating the calculated contract amount. Application 10 creates a reimbursement term for each service that qualifies for this contract term since the rate applies to each service. Therefore application 10 similarly creates another reimbursement term 527 for an X-ray service provided to patient 500 (Ms. Jones) on Jun. 1, 2001 (record 19) that qualifies for this contract reimbursement term. In another embodiment the reimbursement computation may differ for a different contract term requirement. A contract term employing a per diem rate, for example, applies to all charges posted within a day. In which case only one reimbursement term is created for all charges for that day.

Application 10 uses the created reimbursement term information (of terms 519 and 527) in updating the Health Ins. Co. Reimbursement Allocation 515 with the total contract reimbursement amount comprising the sum of the reimbursement term contract amounts of terms 519 and 527. Further, application 10 calculates an expected reimbursement amount for services (of records 17 and 19) by applying benefit information of the patient policy 507. The calculated expected reimbursement amounts are incorporated in corresponding terms 519 and 527. Using the calculated expected reimbursement information, application 10 updates the Health Ins. Co. Reimbursement Allocation 515 with the total expected reimbursement amount due from Health Ins. Co. comprising the sum of the reimbursement term (519 and 527) expected reimbursement amounts. In addition, application 10 also calculates the corresponding guaranteed expected reimbursement term amounts (of term 521) and the total guaranteed expected reimbursement amount of the Guarantor Reimbursement Allocation 517. These amounts reflect the Guarantor potential liability.

The described embodiment of FIG. 5 is readily adapted to cover processing of multiple applicable policies. In this case, application 10 performs a similar procedure for each service covered by an Outpatient Encounter record and for each policy. However, in this case some steps are not repeated for each service and policy. For example, a reimbursement record is created once (not for each policy), for the primary policy, when the first provided service is recorded.

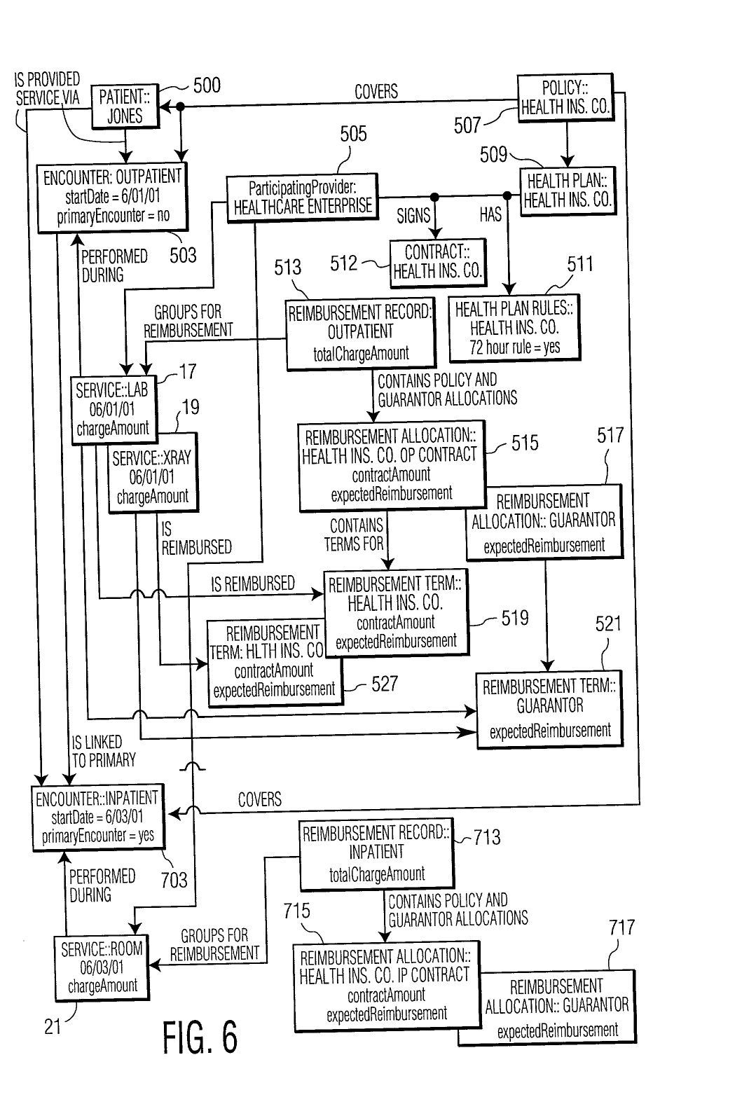

FIG. 6 shows a system employed by application 10 for grouping records of inpatient services provided to a specific patient in a consolidated reimbursement record. Specifically, FIG. 6 illustrates system operation up to the point where application 10 detects that records of outpatient services in an outpatient reimbursement record need to be grouped with the record of inpatient services in an inpatient reimbursement record. This record processing is performed based on reimbursement contract rules specified in a health plan associated with a selected health plan policy. The system is similar to that described in connection with FIG. 5 with the addition that patient 500 (Ms. Jones) is admitted to Hospital on Jun. 3, 2001 (item 703 of FIG. 6), two days after her Outpatient Encounter (of Jun. 1, 2001). The registrar creates a new visit record (an inpatient encounter record 703 of FIG. 6) and once again collects Ms. Jones' policy information via application 10. Ms. Jones still has Health Ins. Co. Policy 507. Application 10 designates the inpatient visit of Jun. 3, 2001 as a primary encounter.

In the exemplary processing embodiment of FIG. 6, following the processing detailed in FIG. 5, a first inpatient service is recorded (item 21 FIG. 1) by application 10 for Ms. Jones' Inpatient Encounter of Jun. 3, 2001. Application 10 in FIG. 6 retrieves a prioritized list of policies applicable to the Inpatient Encounter 21 for the participating provider Healthcare Enterprise 505. In this case the Health Ins. Co. policy 509 is both the sole applicable policy and the primary policy. Application 10 examines Health Ins. Co. plan 509 to see if there are rules defined for grouping services from multiple encounters into one reimbursement record. Application 10 determines that there is a rule 511 requiring combination of records of outpatient services and inpatient services. Specifically, rule 511 requires that records of outpatient services for encounters occurring within 3 days of an inpatient encounter are to be grouped into the same inpatient reimbursement record with the records of associated inpatient services.

Application 10 searches a record repository for other encounter records for patient 500 (Ms. Jones) that satisfies rule 511, for the same primary policy 507, and for the same participating provider, i.e., Healthcare Enterprise 505. In this example, application 10 finds the outpatient encounter record 503 satisfies rule 511. Therefore application 10 links the Outpatient Encounter record 503 with the Inpatient Encounter record 703 and determines under rule 511 that the primary encounter is the Inpatient Encounter (record 703). The Outpatient Encounter of record 503 is no longer primary. Further application 10 collates the service records of the linked encounters and sorts them by date.

Application 10 creates Inpatient Reimbursement record 713 for a primary Inpatient Encounter as well as Reimbursement Allocation 715 for the Inpatient Reimbursement record 713. This is done in a similar manner to the creation of corresponding Outpatient records 513 and 515 created in connection with the system of FIG. 5. The Reimbursement Allocation 715 contains an expected reimbursement amount due from Health Ins Co. for Ms. Jones' Inpatient Encounter of Jun. 3, 2001. Application 10 further creates a Guarantor Reimbursement Allocation 717 for the Inpatient Reimbursement record 713. Guarantor Reimbursement Allocation 717 contains the expected reimbursement amount that is guaranteed by a Guarantor.

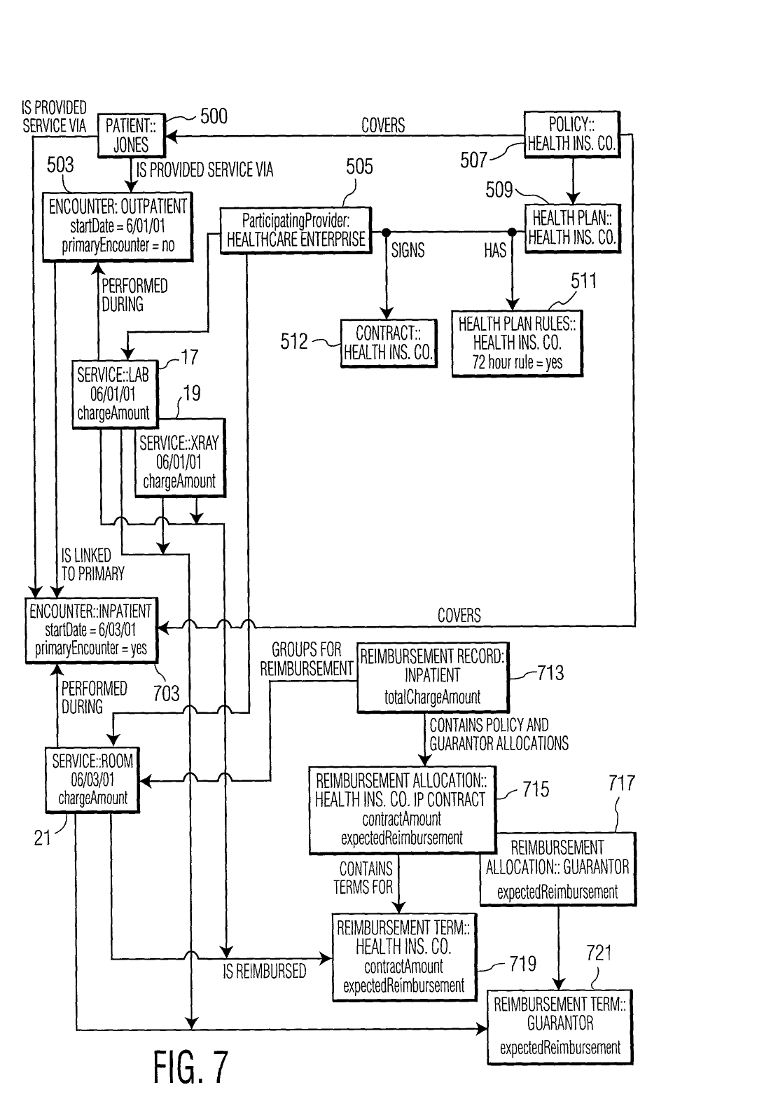

FIG. 7 shows a system employed by application 10 for grouping records of inpatient and outpatient services provided to a specific patient in a consolidated reimbursement record. The system of FIG. 7 is used to successively process service records 21 and records 17 and 19 but in another embodiment the process steps may be employed to process such records together in a parallel manner. In the exemplary processing embodiment of FIG. 7, following the processing detailed in FIG. 6, application 10 retrieves a prioritized list of policies applicable to the primary Inpatient Encounter 703 (of record 21) for the participating provider Healthcare Enterprise 505. In this case the Health Ins. Co. policy 507 is both the sole applicable policy and the primary policy. Application 10 also determines that there is a payer contract 512 defined for Health Ins. Co. Health Plan 509 in which participating provider Healthcare Enterprise 505 participates. Further, application 10 determines that the inpatient service of record 21 (and in successive iterations of the FIG. 7 process that outpatient services of records 17 and 19) qualify for an active contract period and contract package, i.e., an Inpatient Package, based on primary Inpatient Encounter data. This is done since the services of records 17 and 19 that originally qualified for the Outpatient Package now qualify for the Inpatient Package because the Outpatient Encounter is now linked to the Inpatient Encounter and the Inpatient Encounter is designated as primary and the Outpatient Encounter is not. This is previously described in connection with the system of FIG. 6.

In the system of FIG. 7, application 10 searches the record repository for an existing reimbursement record associated with the inpatient encounter 703 and finds the Inpatient reimbursement record 713. Further, application 10 determines that the Inpatient service of Jun. 3, 2001 (service record 21) qualifies for an active benefit period and that this service is covered under plan 509 and policy 507. Further, application 10 determines, based on the primary Inpatient Encounter data and service data of record 21, that the service provided on Jun. 3, 2001 qualifies for a contract reimbursement term, i.e., an Inpatient Services term (409 of FIG. 4). Further, the contract reimbursement term comprises a contract rate comprising a predetermined amount per case. Similarly, application 10 in successive iterations of the FIG. 7 process determines that the outpatient services of records 17 and 19 provided on Jun. 1, 2001 qualify for the same contract rate reimbursement term comprising a predetermined amount per case.

Application 10 calculates the contract reimbursement amounts for services of records 17, 19 and 21 and creates a reimbursement term 719 incorporating the calculated contract amounts. Application 10 creates one reimbursement term for inpatient and outpatient charges of records 17, 19 and 21 that qualify for the Inpatient Services contract term because these charges are covered by the contract reimbursement rate comprising a single reimbursement sum per case. Application 10 uses the created reimbursement term information of term 719 in updating the Health Ins. Co. Reimbursement Allocation 715 with the total contract reimbursement amount comprising the sum of the reimbursement term contract amounts for services of records 17, 19 and 21. Further, application 10 also calculates expected reimbursement amounts for the services of records 17, 19 and 21 by applying benefit information of the patient policy 507. The calculated expected reimbursement amounts are incorporated in term 719. Using the calculated expected reimbursement information, application 10 updates the Health Ins. Co. Reimbursement Allocation 715 with the total expected reimbursement amount comprising the sum of the expected reimbursement amounts for all Health Ins Co. reimbursement terms, in this case just 719 which includes services of records 17, 19 and 21. In addition, application 10 also calculates the corresponding guaranteed expected reimbursement term 721 amounts (for services of records 17, 19 and 21). Application 10 thereby computes the total guaranteed expected reimbursement amount comprising the sum of reimbursement amounts for all Guarantor reimbursement terms, in this case just 721 which includes services of records 17, 19 and 21 for the Guarantor Reimbursement Allocation 717. These amounts reflect the Guarantor potential liability.

The architectures and processes presented in FIGS. 1-7 are not exclusive. Other architectures and processes may also be derived in accordance with the principles of the invention to accomplish the same objectives. Further, the inventive principles may be advantageously employed in any application where charges are posted to separate accounts for a single entity and rules are established or may be derived to direct the combination of charges from those accounts into one reimbursement record for common reimbursement.

Exemplary and non-limiting Glossary of Terms Related to a Healthcare
embodiment.

| Term | Definition |
|---|---|
| Charge | The dollar amount associated with a performed service. This |
| | amount can be manually entered, but is usually calculated |
| | based on rules in the service definition. |
| Claim | A demand for a sum of money due from a payer for one or |
| | more services rendered. |
| Contract | The amount agreed upon by the payer and the provider for a |
| Amount | service or grouping of services as specified in the payer |
| | contract. |
| Encounter | The one-time contact between the patient and Health |
| | Professional (HP) bounded by both an implicit or explicit start |
| | and end. The range of encounters includes the admission to |
| | the hospital (even for a lengthy stay) or a phone call to a HP. |
| | Each visit (or call) constitutes an encounter. The Encounter is |
| | meant to capture the smallest interaction that has meaning to |
| | the enterprise. |
| | Some other terms often used as synonyms for encounter |
| | include Case, Visit, or Stay. |
| Enterprise | A collection of one or more health provider organizations |
| | and/or health professionals joined together for the purpose of |
| | providing healthcare services. |
| Expected | The payment expected from a single payer in connection with |
| Reim- | a reimbursement record. It is determined by a combination of |
| bursement | the payer contract rules and health plan benefit rules. |
| Guarantor | The person or organization who promises or guarantees to pay |
| | for that portion of the patient's health related services that are |
| | not covered by the patient's health (insurance) plan. |
| Health | A specific, salable product “offering” that includes a set of |
| Plan | health service benefits offered directly to the public or via |
| | sponsors to the employees or members of the sponsoring |
| | organization. There are many varieties of health plans such as |
| | indemnity, managed care, Preferred Provider Organization |
| | (PPO), Point of Service (POS), etc. |
| Health | An individual, such as a physician, nurse, social worker, |
| Pro- | counselor, etc., who is qualified to participate in the |
| fessional | identification, prevention, or treatment of an illness or |
| | disability. The individual is entitled by training and experience |
| | to practice their profession. Often such practice requires |
| | licensure, and law prescribes the boundaries of the practice. |
| Health | An organization through which individuals cooperate |
| Provider | systematically to provide health services. It is a general term |
| Organi- | that describes any level within a health corporation's organiza- |
| zation | tional hierarchy that either directly provides (health) services |
| | to consumers (e.g., a hospital, a department or sub-depart- |
| | ment,) or the hierarchical parent of an organization that |
| | directly provides services to consumers (e.g., a health |
| | corporation). |
| Partici- | This class represents a role that can be played by either the |
| pating | Health Provider Organization (HPO) or Health Professional |
| Provider | Service Provider (i.e. an HP that is a member of a Service |
| | Providing HPO). |
| | The other key association of this class is to a reimbursement |
| | record. An HPO or HP (member) is an entity, which has a |
| | relationship with the primary plan for a receivable. |
| | The Participating Provider: |
| | 1) May direct the assembly of Reimbursement records onto a |
| | given Claim, e.g., Reimbursement records with different |
| | Participating Providers typically do not appear on the same |
| | claim. |
| | 2) Designates which organization or health professional is to |
| | be the basis for expected reimbursement. |
| | 3) Identifies the organization or individual that the payer most |
| | likely recognizes as asking for payment. In many cases this is |
| | the same person or organization that performed the service(s), |
| | but in other cases it is not. |
| Patient | A person who has received services from a healthcare |
| | provider. |
| Payer | An organization (or person) that markets and administers |
| | health plans and who pays for or underwrites coverage for |
| | healthcare expenses. A payer may be the government |
| | (Medicare), a nonprofit organization (Blue Cross/Blue Shield), |
| | a commercial insurance, or some other organization, person, |
| | or entity. In common usage, “payer” most often means third- |
| | party payer, i.e., organization or person who neither receives |
| | nor provides the service. The individual receiving the |
| | healthcare service is the first party. The HP or HPO providing |
| | the service is the second party. |
| Policy | A contractual arrangement stating that a Payer will grant the |
| | benefits of a given Health Plan to the contract holder (or |
| | subscriber) and his or her beneficiaries. A Policy can also be |
| | considered a specific instance of a Health Plan. |
| Primary | The encounter that determines which contract and benefit |
| Encounter | rules apply and is associated with reimbursement record |
| | creation. |
| Rate | The formula that specifies how services that qualify for a |
| | particular contract term are reimbursed. Examples include per |
| | case, per diem, percentage of charges, etc. |
| Reim- | The allocation of total extended price amount to a specific |
| bursement | responsible party for all the services associated with the |
| Allocation | Reimbursement record as determined by the contract, benefits |
| | and the coordination of them between payers. Includes both |
| | expected amounts and actual amounts. The allocation equals |
| | the sum of the reimbursement terms for the reimbursement |
| | allocation. |
| Reim- | A reimbursement term is created for one or more services that |
| bursement | qualified for a particular contract term within the contract |
| Term | package for a particular payer contract. Expected reimburse- |
| | ment for the reimbursement term is calculated based on the |
| | rate defined in the contract term, to which benefits are then |
| | applied. If there is no contract, a reimbursement term is |
| | created for each service and expected reimbursement is |
| | calculated based on benefits alone. |
| | If the contract term is per diem then a reimbursement term is |
| | created for each day. If the contract term is percentage, then a |
| | reimbursement term is created for each service. If a contract |
| | term is per case, then one reimbursement term is created. |
| | Reimbursement terms for the guarantor reimbursement |
| | allocation are created according to the following rules: |
| | If the patient has any active policies (payers) for the service |
| | and any of the payers qualified for a payer contract, then one |
| | reimbursement term is created for the guarantor allocation. |
| | If the patient does not have any active policies for this service |
| | or none of the payers qualified for a payer contract, then one |
| | reimbursement term is created per service for the guarantor |
| | allocation. |
| Reim- | This refers to that grouping of services needed to correctly |
| bursement | calculate expected reimbursement, bill, and perform follow- |
| Record | up. In the health care field, services are initially associated |
| | with an Encounter, thereby allowing the clinician the “view” |
| | of the data that they require. The Reimbursement record |
| | provides another view of those services (charges) and is based |
| | on specific reimbursement rules. |
| | A Reimbursement record is a particular grouping of services |
| | for one or more encounters that will be reimbursed together |
| | by the primary responsible party as a unit. If a contract exists |
| | services are allocated to a reimbursement record by the |
| | contract package they qualify for. If no contract exists then |
| | services are allocated to a reimbursement record according |
| | health plan rules and the primary encounter. |
| Remit- | An explanation of payment forwarded to a Business Office for |
| tance | a service or services rendered and reported on a given claim. |
| | Along with a statement of how much money was paid, the |
| | Remittance response also contains information about any |
| | adjustments the insurance may perceive as valid, as well as |
| | deductibles, coinsurance, etc. |
| | The Remittance response sometimes contains explanations as |
| | to the overall status of the claim or why payment may have |
| | been reduced or denied. |
| Service | A significant activity or task done to or for a patient on a |
| | specific date and time. Any material or supply dispensed |
| | (including drugs), any facilities or equipment used, any |
| | administrative service provided (e.g., television), or any |
| | financial service provided (e.g., credit check). Detail data that |
| | fully describe the delivery of that service are typically |
| | recorded with it (e.g., what, who, when, why, where, and |
| | how). If the service represents a set of activities (based on the |
| | Service Definition), each discrete service it represents is also |
| | recorded. General guidelines are: procedures tend to be |
| | distinct actions, and carried out in a brief time as a surgical |
| | operation (a procedure or group of procedures); services (such |
| | as preoperative and postoperative care) are less distinct and |
| | are carried out over longer (and variable) periods of time. For |
| | purposes of payment, a “service” (or procedure) might more |
| | accurately be defined as “the unit for which a charge is |
| | made.” |

what is claimed is:

1. A method for determining payment for provision of multiple different services based on predetermined reimbursement rules, comprising the steps of:
receiving a record identifying a service provided to a specific entity;
automatically creating a reimbursement record grouping an item identifying said provided service together with an item identifying an other service provided to said specific entity based on predetermined service record allocation rules; and
calculating a reimbursement amount for said identified provided service and said other service provided to said specific entity based on a reimbursement contract.

2. A method according to claim 1, wherein
said step of automatically creating a reimbursement record comprises creating a reimbursement record without manual intervention from received records identifying different types of services provided to said specific entity on separate occasions.

3. A method according to claim 2, wherein
said different types of services comprise an outpatient service and an inpatient service.

4. A method according to claim 1, wherein
said predetermined service record allocation rules comprise at least one of, (a) rules determining whether said provided service as well as said other service qualify for reimbursement under at least one reimbursement contract, and (b) rules in a reimbursement contract.

5. A method according to claim 1, wherein
said reimbursement contract comprises a healthcare policy covering said specific entity and said specific entity comprises a patient.

6. A method according to claim 1 implemented as a program of instructions contained on a storage medium and executable by a machine.

7. A user interface supporting a method for determining payment for provision of multiple different services based on predetermined reimbursement rules, comprising the steps of:
generating a first user selectable menu icon for initiating display of a reimbursement record, said reimbursement record showing
a group of items including an item identifying a service provided to a specific entity together with an item identifying an other service provided to said specific entity based on predetermined service record allocation rules; and
calculated reimbursement amounts for said identified provided service and said other service provided to said specific entity based on a reimbursement contract.

8. A method according to claim 7, including the step of
generating a second user selectable menu icon for initiating display of a bill including said reimbursement amount for said provided service and said other service.

9. A method for use in billing for provision of multiple different services based on predetermined reimbursement rules, comprising the steps of:
receiving a record identifying a service provided to an entity;
applying predetermined allocation rules for identifying a reimbursement record indicating a group of services to be billed together on a single bill, said group of services having been provided to said entity;
updating said identified reimbursement record to incorporate a record item representing said identified provided service;
calculating a reimbursement amount for said identified provided service based on predetermined reimbursement rules; and
preparing a bill including said group of services and said identified provided service for communication to a payer.

10. A method according to claim 9, wherein
said predetermined allocation rules comprise rules for determining said identified provided service as well as said group of services qualify for reimbursement under at least one of (a) a single reimbursement contract and (b) a common set of reimbursement contracts.

11. A method according to claim 9, wherein
said predetermined allocation rules comprise rules in a reimbursement contract.

12. A method according to claim 9, wherein
said predetermined allocation rules identify a reimbursement record to incorporate a record item representing said identified provided service based on the type of said identified provided service.

13. A method according to claim 12, wherein
said type of said identified provided service comprises at least one of, (a) an inpatient service, (b) an outpatient service and (c) an emergency service.

14. A method according to claim 9, including the step of
identifying and prioritizing at least one of (a) reimbursement contracts and (b) policies, comprising predetermined reimbursement rules and
selecting said predetermined reimbursement rules from said prioritized and identified predetermined reimbursement rules for calculating reimbursement for said identified provided service.

15. A method according to claim 9, wherein
said reimbursement record indicates said group of services are reimbursable according to rules in a single reimbursement contract and including the step of
determining whether said identified service is also reimbursable according to rules in said single reimbursement contract.

16. A method according to claim 9, wherein
said specific entity comprises at least one of, (a) a patient, (b) a company, (c) an individual person and (d) a group of people and including the step of
searching for other services also provided to said specific entity.

17. A method for determining payment for provision of multiple different services based on predetermined reimbursement rules, comprising the steps of:
receiving a record identifying a service provided to a specific entity;
searching for a record of an additional service provided to said specific entity;
determining whether said identified service as well as said additional service provided to said specific entity qualify for reimbursement under a single reimbursement contract;
creating a record indicating said identified service and additional service provided to said specific entity qualify for reimbursement under a single reimbursement contract; and
calculating a reimbursement amount for said identified service and additional service provided to said specific entity based on said single reimbursement contract.

18. A method according to claim 17, including the step of
preparing a bill including said reimbursement amount for said identified service and additional service for communication to a payer.

19. A method according to claim 17, wherein
said specific entity comprises at least one of, (a) a patient, (b) a company, (c) an individual person and (d) a group of people.

20. A method according to claim 17, including the steps of
identifying and prioritizing at least one of, (a) reimbursement contracts and (b) policies associated with reimbursement contracts, applicable for reimbursing for said identified service and additional service and
selecting said single reimbursement contract from one of, (i) said prioritized reimbursement contracts and (ii) said reimbursement contracts associated with said prioritized policies.

21. A method according to claim 17, including the step of
searching for other services also provided to said specific entity.

22. A method according to claim 17, including the step of
sorting said identified service and additional service by date service is performed.

23. A method for determining payment for provision of multiple different services based on predetermined reimbursement rules, comprising the steps of:
receiving a record identifying a service provided to a specific entity;
searching for a reimbursement record indicating at least one other service provided to said specific entity;
determining whether said identified service as well as said at least one other service provided to said specific entity qualify for reimbursement under a single reimbursement contract;
updating said reimbursement record to incorporate a record item representing said identified provided service in response to determination of said qualification; and
calculating a reimbursement amount for said identified service and one other service provided to said specific entity based on said single reimbursement contract.

24. A method according to claim 23, including the step of
preparing a bill including said reimbursement amount for said identified service and one other service for communication to a payer.

25. A method according to claim 23, wherein
said reimbursement record indicates services provided to said entity within a specific period and wherein said updating step comprises
updating said reimbursement record to incorporate said record item representing said identified provided service in response to determination said identified provided service was provided within said specific period.

26. A method according to claim 23, including the step of
preparing a bill including said reimbursement amount for said identified service and one other service for communication to a payer.

27. A method according to claim 23, including the step of
determining said identified provided service as well as said group of services qualify for reimbursement under at least one of (a) a single reimbursement contract and (b) a common set of reimbursement contracts.
